(19) United States
(12) Patent Application Publication
(10) Pub. No.: US 2010/0179973 A1
(43) Pub. Date: Jul. 15, 2010

(54) SYSTEMS, METHODS, AND COMPUTER PROGRAMS FOR DELIVERING CONTENT VIA A COMMUNICATIONS NETWORK

(76) Inventor: HERVE CARRUZZO, Atlanta, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 12/650,774

(22) Filed: Dec. 31, 2009

Related U.S. Application Data
(60) Provisional application No. 61/141,681, filed on Dec. 31, 2008.

(51) Int. Cl. G06F 17/30

(52) U.S. Cl. 707/827; 707/E17.01

(57) ABSTRACT

Various embodiments of systems, methods, and computer programs are provided. One embodiment is a method for delivering content to computing devices via a communications network. One such method comprises: storing a plurality of content files in a master storage system, the content files comprising a header identifying a location of the content file in a file system and a plurality of blocks of data; initially storing one or more of the content files in a content server with the header and only an initial portion of the blocks of data; the content server receiving a request for the content file from a computing device; the content server providing the initial portion to the computing device; the content server requesting additional blocks of data from the master storage system; the content server providing the additional blocks to the computing device; and the content server storing the additional blocks with the content file.

### CROSS-REFERENCE TO RELATED APPLICATION

This application claims the benefit of the priority of U.S. Provisional Patent Application Ser. No. 61/141,681 entitled “Systems, Methods, and Computer Programs for Delivering Content via a Communications Network,” and filed Dec. 31, 2008, the entire contents of which is hereby incorporated by reference.

### BACKGROUND

A content delivery network or content distribution network (CDN) is a system of strategically placed servers that are networked together over a communications network (e.g., the Internet) for delivering content to users. The delivered content typically comprises any combination of audio and/or video or other data and may include associated functionality such as computer applications. Typically, a CDN is operated by an application service provider via the Internet and is used to provide network services to content providers, although an increasing number of network owners and large content providers may provide their own private CDN. The purpose of the CDN is to improve delivery performance, scalability and cost efficiency to content and/or service providers who deliver content to a large number of end users.

In a CDN and other content delivery solutions, there are two general approaches for distributing the content to the strategically located servers (commonly referred to as edge servers), which are typically located near the end users. One approach involves replication, and the other approach involves caching. Replication involves pre-populating the content to be distributed at each of the edge servers. For example, the content may be uploaded in one location and then copied to multiple edge servers, with each edge server typically maintaining the content according to the same filesystem based on file names and a directory or other file structure. The advantage of this approach is that the content files are located at each end point and, therefore, the content delivery time may be reduced. This advantage, however, comes at a significant cost in implementing and maintaining redundant data storage.

The second approach involves caching the content to be delivered. In the caching approach, the content files may be stored at a central storage system. When an end user requests content from an edge server, a caching mechanism determines if the content is stored locally in association with the edge server. If not, the edge server may request the data from the central storage system. When the edge server receives the data, it is provided to the end user and then stored locally so that the next time an end user asks for it, it is available without having to request it from the central storage system. While caching may reduce the overhead associated with the replication approach, the process of requesting and receiving the content from the central storage system may cause an undesirable time delay or lag. Another disadvantage is that the caching mechanism (typically a separate or integrated caching server) is typically configured in such a way that only the caching server may access the cached content because the caching operation occurs at the level of the application requesting the content. Furthermore, because the caching occurs at the application level, a separate caching operation may be required for each application requesting content from the edge server, which may increase the cost and complexity of the caching server.

Despite the commercial success of, and increasing demand for, content delivery solutions, there remains a need for systems, methods, and computer programs for delivering content with improved performance, scalability, and cost efficiency.

### SUMMARY

Various embodiments of systems, methods, and computer programs are provided. One embodiment is a method for delivering content to computing devices via a communications network. One such method comprises: storing a plurality of content files in a master storage system, the content files comprising a header identifying a location of the content file in a file system and a plurality of blocks of data; initially storing one or more of the content files in a content server with the header and only an initial portion of the blocks of data; the content server receiving a request for the content file from a computing device; the content server providing the initial portion to the computing device; the content server requesting additional blocks of data from the master storage system; the content server providing the additional blocks to the computing device; and the content server storing the additional blocks with the content file.

Another embodiment is a computer system for delivering content to computing devices via a communications network. The computer system comprises a master storage system and a content server configured to communicate via a communications network. The master storage system stores a content file comprising a header identifying a location of the content file in a file system and a plurality of blocks of data. The content server initially stores the content file via the file system with the header and one or more initial blocks of data. The content server is further configured to: receive a request for the content file from a computing device via the communications network; read the content file from the file system; provide the initial blocks of data to the computing device; and if additional blocks of data in the content file are to be provided to the computing device: request the additional blocks from the master storage system; receive the additional blocks from the master storage system; provide the additional blocks to the computing device; and store the additional blocks in the file system with the content file.

Yet another embodiment is a computer program embodied in a computer-readable medium and executable by one or more servers. The computer program comprises logic configured to: receive a request for a content file from a computing device via a communications network; read the content file from a local file system, the content file initially comprising a header identifying a location of the content file in the local file system and one or more initial blocks of data in the content file; provide the initial blocks of data to the computing device; and if additional blocks of data in the content file are to be provided to the computing device: request the additional blocks from a remote file system associated with a master storage system, the local file system and the remote file system having the same file structure and the master storage system storing all of the blocks of data in the content file; receive the additional blocks from the master storage system; provide the additional blocks to the computing device; and store the additional blocks in the local file system with the content file.

### BRIEF DESCRIPTION OF THE DRAWINGS

FIG. 1 is a block diagram illustrating an embodiment of a computer system for delivering content.

FIG. 2 is a data diagram illustrating an embodiment of a data structure for the content files in the file structure of FIG. 1.

FIG. 3 is a schematic illustration of a data structure for initially storing the content files in the cache of FIG. 1.

FIG. 4 is a flow chart illustrating an embodiment of a method for delivering a content file via the computer system of FIG. 1.

FIG. 5 illustrates the data structure of FIG. 3 after additional blocks of data have been received from the master storage system and cached by the content server.

FIG. 6 is a block diagram of another embodiment of a computer system for delivering content.

FIG. 7 is a combined flow/block diagram illustrating an embodiment of the operation of the computer system of FIG. 6.

FIG. 8 illustrates an embodiment of a virtual filesystem for the computer systems of FIGS. 1, 6 and 7.

FIG. 9 illustrates some advantages of the systems and methods of FIGS. 1-8 for large content files.

FIG. 10 is a combined flow/block diagram of another embodiment of a computer system for delivering content via a live stream.

FIG. 11 illustrates some advantages of the computer system of FIG. 10.

### DETAILED DESCRIPTION

Various embodiments of systems, methods, and computer programs are disclosed for delivering content via a communications network. It should be appreciated that the delivered content may comprise any combination of data, information, and/or functionality, including, for example, audio and/or video files, images, graphics, and any associated or standalone functionality. It should be further appreciated that the content may be delivered as a download, progressive download, streaming content, or any other delivery mechanism suitable for the particular type of content or context.

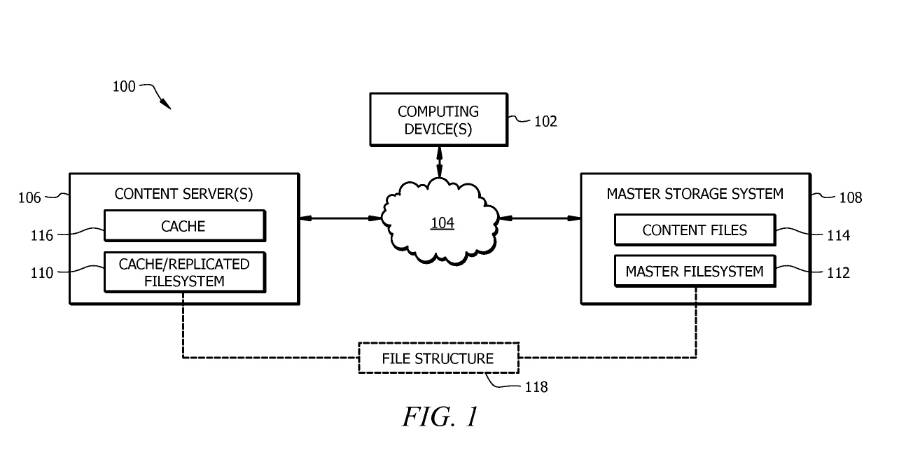

FIG. 1 illustrates an exemplary computer system 100 for delivering content to a computing device 102 via a communications network 104, such as, for example, the Internet or any other suitable communications network. Computer system 100 comprises one or more content servers 106 and a master storage system 108 that communicate with each other and/or the computing devices 102 via the communications network 104. It should be appreciated that the computing devices 102 may comprise a portable computing device (e.g., a mobile phone, a personal digital assistant, a notebook or laptop) or a non-portable computing device (e.g., a personal computer, server, etc.) that supports communication with the master storage system 108 and/or the content server(s) 106 via the communications network 104. The particular supporting communication protocols are not relevant to the particular embodiments described, and as such any communication protocol(s) may be used.

In general, the master storage system 108 and the content server(s) 106 comprise the infrastructure for delivering content (e.g., one or more content files 114) to the computing devices 102 via the communications network 104. Although not necessary, in an embodiment, the master storage system 108 and the content servers 106 may be implemented in a content delivery network (CDN). Therefore, the content server(s) 106 and/or the master storage system 108 may include additional internal and/or external system components and functionality for optimally routing traffic from the computing devices 102 to a particular content server 106. The CDN may be provided as an application service to content providers, or a content provider or network provider may deliver the content via a private CDN. One of ordinary skill in the art will appreciate that the computer system 100 may be implemented outside of the CDN content.

Referring to FIG. 1, the master storage system 108 stores the complete content files 114 that may be delivered to the computing devices 102 via the content servers 106. The content files 114 are stored in accordance with a master filesystem 112, which has the same file structure 118 as a cache/replicated filesystem 110 used to cache the content files 114 in the content servers 106.

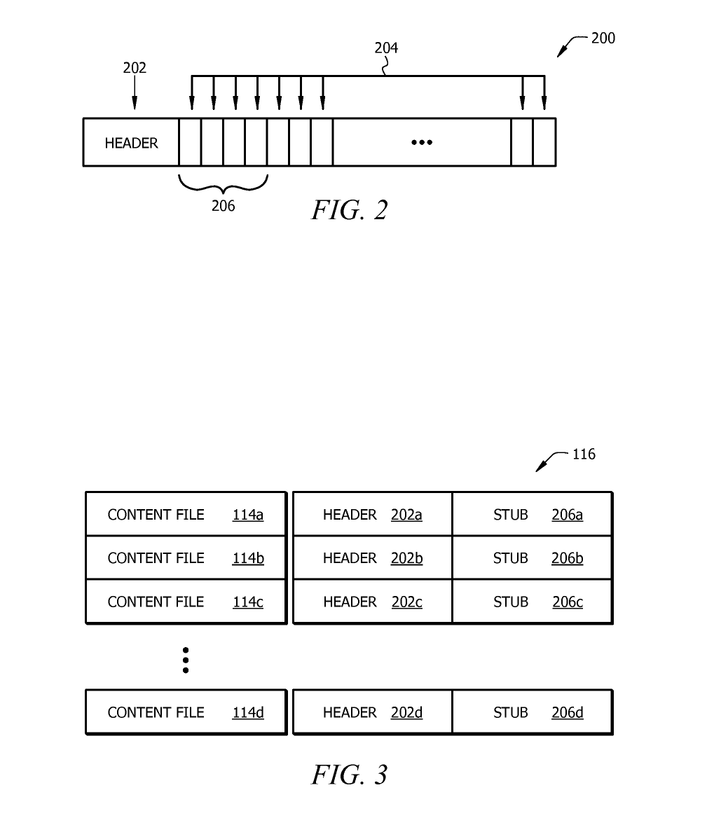

As illustrated in FIG. 2, the content files 114 may include a header 202 and a plurality of blocks of data (i.e., blocks 204). The header 202 may include various types of data related to the underlying content files and/or the file structure 118. For example, in an embodiment, the header 202 may contain metadata about the content, the location(s) of the content file 114, and the size of the content file 114. As known in the art, the blocks 204 comprise individual blocks of data associated with the content. Each block 204 represents a sequence of bytes having a nominal length or block size. For each content file 114, the master storage system 108 stores the header 202 and all of the blocks 204 in the content file 114. The content servers 102 may initially store, in cache 116, only the header 202 and an initial portion 206 of the blocks 204 for a content file 114. When a computing device 102 makes a request for a particular content file 114, the content server 106 may immediately provide the initial portion 206 to the computing device 102 without the delay associated with querying the master storage system 108. As additional blocks 204 are needed, the content server 102 may request the data from the master storage system 108 and then cache the additional blocks for subsequent requests for the content file 114. In this manner, the computer system 100 provides a unique content delivery solution having certain benefits of both the replication and cache approaches described above but without certain disadvantages. For example, the content servers 106 may reduce the storage overhead of traditional replication approaches by only storing the initial portion 206 of the content files 114. Furthermore, the complexity of the cache 116 may be reduced because the caching operation may be integrated with the cache/replicated filesystem 110 rather than being handled at the application level.

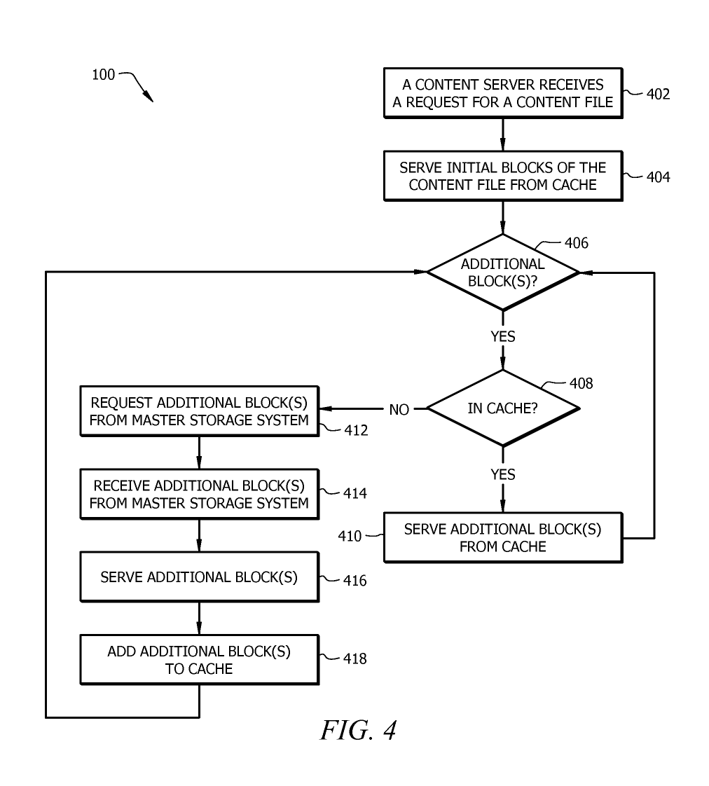

Having described the general components and operation of the computer system 100, the architecture, operation, and/or functionality of an embodiment of the content server 106 will be described with reference to the flow chart illustrated in FIG. 4. One of ordinary skill in the art will appreciate that the process descriptions or blocks associated with the flowchart of FIG. 4 may represent modules, segments, logic or portions of code which include one or more executable instructions for implementing logical functions or steps in the process. It should be further appreciated that any logical functions may be executed out of order from that shown or discussed, including substantially concurrently or in reverse order, depending on the functionality involved, as would be understood by those reasonably skilled in the art. Furthermore, the logical functions may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or transport the program for use by or in connection with the instruction execution system, apparatus, or device.

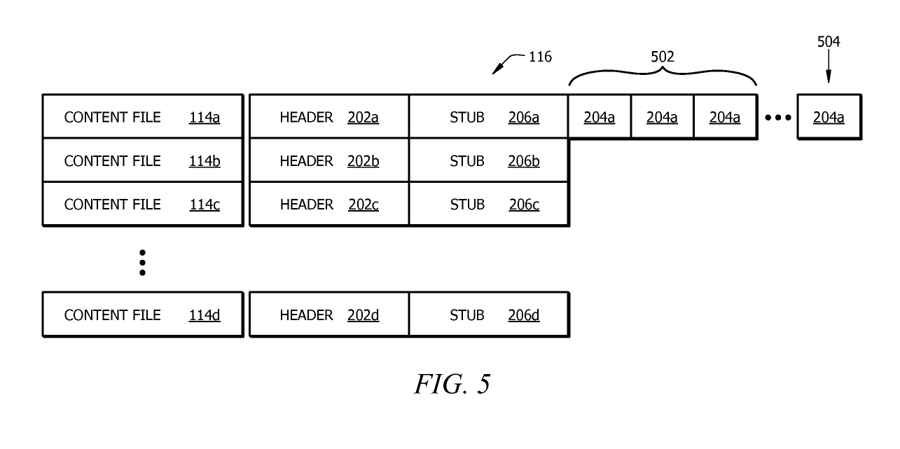

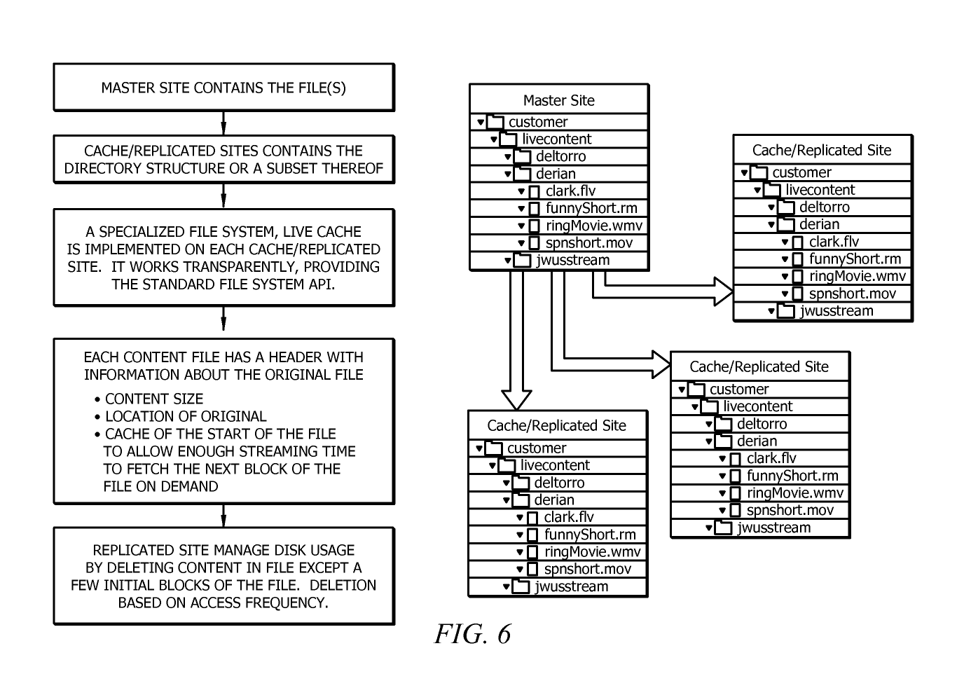

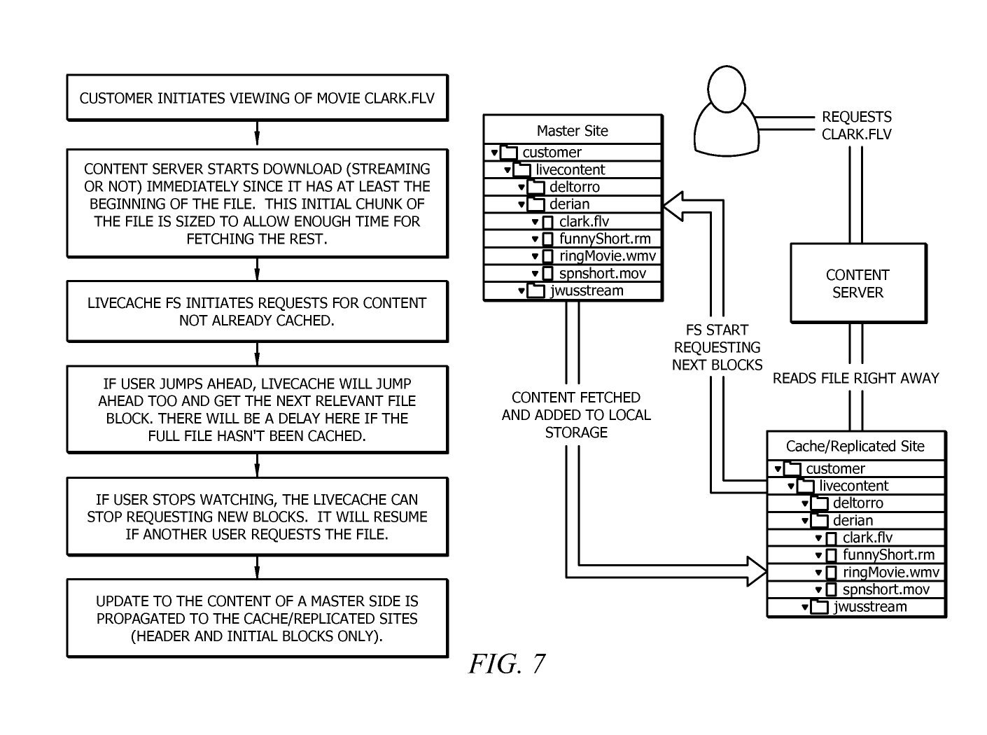

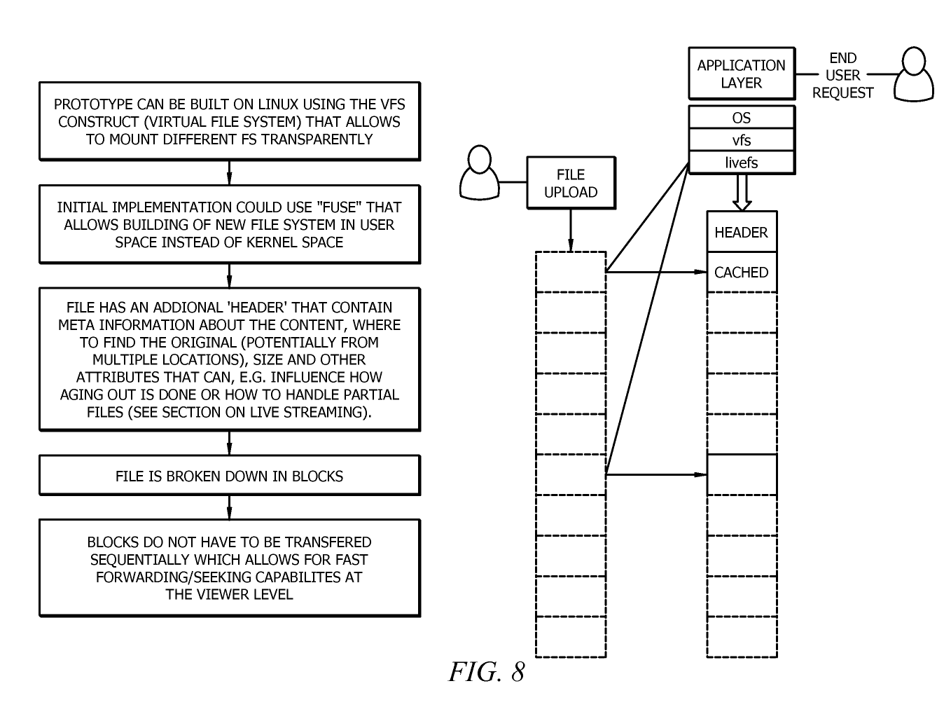

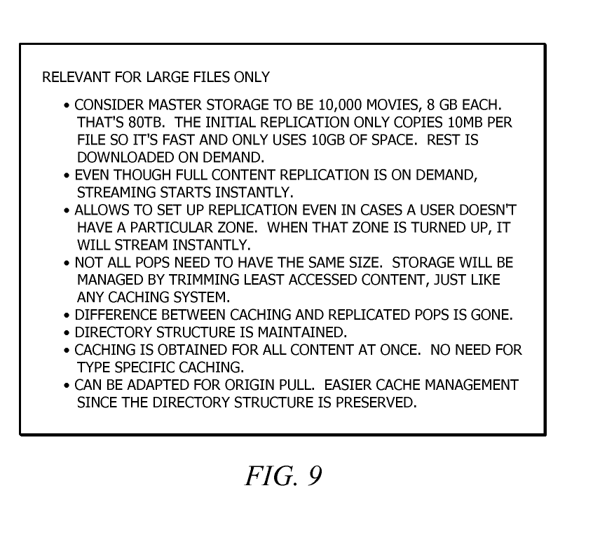

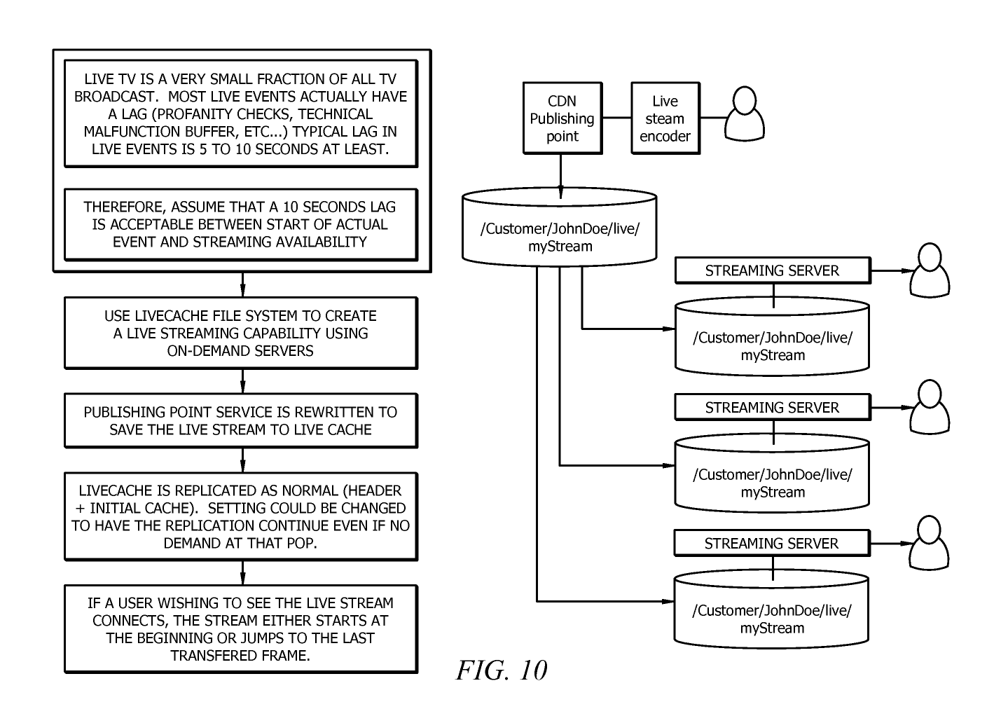

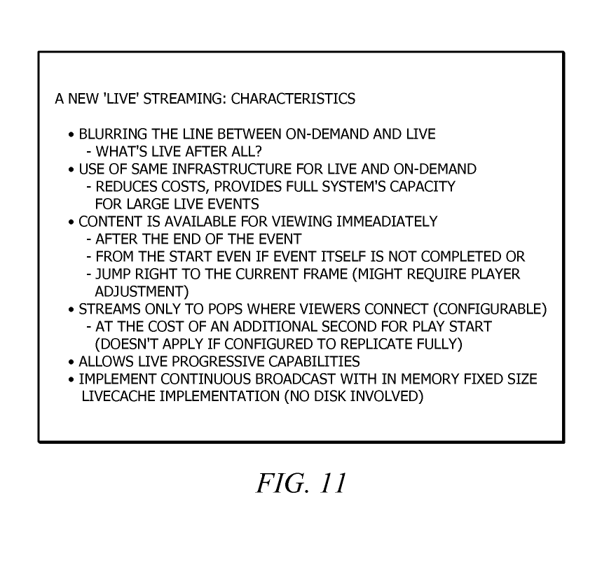

At block 402, the content server 102 receives a request for a content file 114 from a computing device 102. If the content file 114 is located in cache 116, at block 404, the content server 106 may immediately provide to the computing device 102 the initial portion 206 of the content file 114. As mentioned above, the blocks 204 may be delivered to the computing device 102 in any suitable manner, including, for example, as a download, as a progressive download, or as streaming content. At decision block 406, the content server 106 may determine whether additional blocks 204 are to be delivered. As additional blocks 204 are to be delivered, the content server 106 determines whether the blocks are cached (decision block 408). If the additional blocks 204 have previously been cached (or otherwise stored locally), the content server 106 provides the additional data to the computing device 102. If the additional blocks 204 are not cached, at block 412, the content server 106 may request the additional blocks 204 from the master storage system 118. At block 414, the content server 106 receives the additional blocks 204. At block 416, the content server 102 delivers the additional blocks 204 to the computing device 102. As illustrated in FIG. 5 and at block 418, the content server 102 may cache the additional blocks 204 and return control to decision block 406.

It should be noted that this disclosure has been presented with reference to one or more exemplary or described embodiments for the purpose of demonstrating the principles and concepts of the invention. The invention is not limited to these embodiments. As will be understood by persons skilled in the art, in view of the description provided herein, many variations may be made to the embodiments described herein and all such variations are within the scope of the invention.

1. A computer system for delivering content to computing devices via a communications network, the computer system comprising:
a master storage system configured to communicate via a communications network, the master storage system storing a content file comprising a header identifying a location of the content file in a file system and a plurality of blocks of data; and
a content server configured to communicate with the master storage system via the communications network, the content server initially storing via the file system the header and one or more initial blocks of data in the content file, the content server further configured to:
receive a request for the content file from a computing device via the communications network;
read the content file from the file system;
provide the initial blocks of data to the computing device; and
if additional blocks of data in the content file are to be provided to the computing device:
request the additional blocks from the master storage system;
receive the additional blocks from the master storage system;
provide the additional blocks to the computing device; and
store the additional blocks in the file system with the content file.

2. The computer system of claim 1, wherein the file system comprises one or more of a disk file system, a network file system, and a virtual file system.

3. A computer program embodied in a computer-readable medium and executable by one or more servers, the computer program comprising logic configured to:
receive a request for a content file from a computing device via a communications network;
read the content file from a local file system, the content file initially comprising a header identifying a location of the content file in the local file system and one or more initial blocks of data in the content file;
provide the initial blocks of data to the computing device; and
if additional blocks of data in the content file are to be provided to the computing device:
request the additional blocks from a remote file system associated with a master storage system, the local file system and the remote file system having the same file structure and the master storage system storing all of the blocks of data in the content file;
receive the additional blocks from the master storage system;
provide the additional blocks to the computing device; and
store the additional blocks in the local file system with the content file.

4. The computer program of claim 3, wherein one or both of the local file system and the remote file system comprise one or more of a disk file system, a network file system, and a virtual file system.

5. The computer program of claim 3, further comprising logic configured to:
receive a subsequent request for the content file; and
provide the initial blocks and the additional blocks of the content file from the local file system.

6. A method for delivering content to computing devices via a communications network, the method comprising:
storing a plurality of content files in a master storage system, the content files comprising a header identifying a location of the content file in a file system and a plurality of blocks of data;
initially storing one or more of the content files in a content server with the header and only an initial portion of the blocks of data;
the content server receiving a request for the content file from a computing device;
the content server providing the initial portion to the computing device;
the content server requesting additional blocks of data from the master storage system;
the content server providing the additional blocks to the computing device; and
the content server storing the additional blocks with the content file.

7. The method of claim 6, further comprising:
the content server receiving a subsequent request for the content file;
the content server providing the initial portion and the additional blocks from a cache.

8. The method of claim 6, wherein the file system comprises one or more of a disk file system, a network file system, and a virtual file system.
